(19) United States
(12) Patent Application Publication
(10) Pub. No.: US 2011/0116258 A1
(43) Pub. Date: May 19, 2011

(54) DISPLAY DEVICE

(75) Inventor: XIAO-FENG MA, Shenzhen City (CN)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/650,414

(22) Filed: Dec. 30, 2009

(30) Foreign Application Priority Data
Nov. 16, 2009 (CN) 200910309759.7

(51) Int. Cl. F21V 21/00

(52) U.S. Cl. 362/217.13

(57) ABSTRACT

A display device includes a casing and a screen mounted in the casing. A slot is defined in the casing. An illumination device is received and mounted in the slot.

### BACKGROUND

1. Technical Field

The present disclosure concerns display devices, and particularly to a display device having an illumination device.

2. Description of Related Art

People often use a reading lamp alongside a desktop computer (“PC”) to see better. Ordinarily, several peripheral devices comprising power source, sound boxes and scanner cram the display device's vicinity with minimal space available for any reading lamp.

A new display device is therefore required to overcome the foregoing shortcomings.

### BRIEF DESCRIPTION OF THE DRAWINGS

FIG. 1 is an exploded, isometric view of a display device according to an exemplary embodiment.

FIG. 2 is an assembled, isometric view of the display device of FIG. 1, with an illumination device of the display device being exposed.

FIG. 3 is similar to FIG. 2, with the illumination device of the display device being hid.

### DETAILED DESCRIPTION

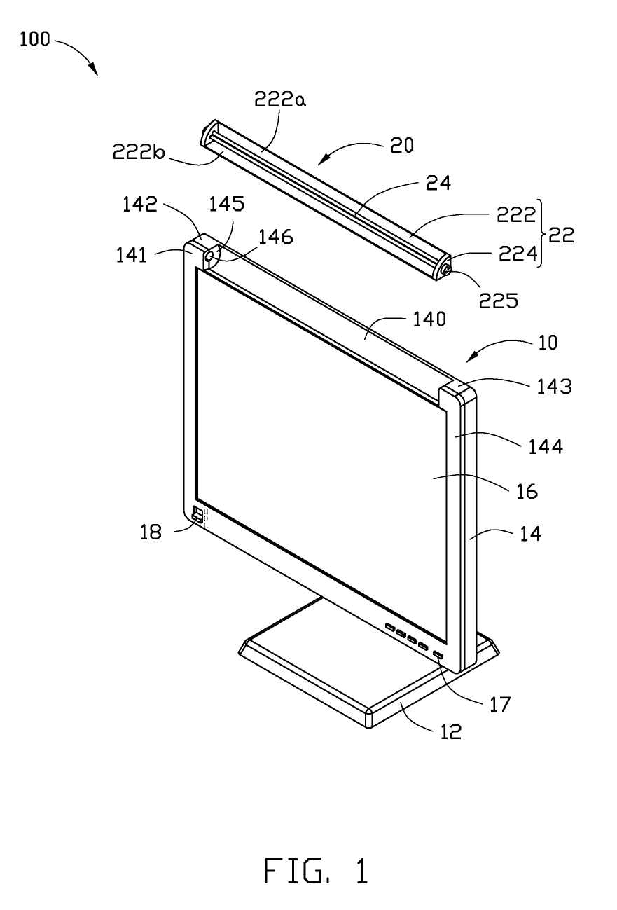

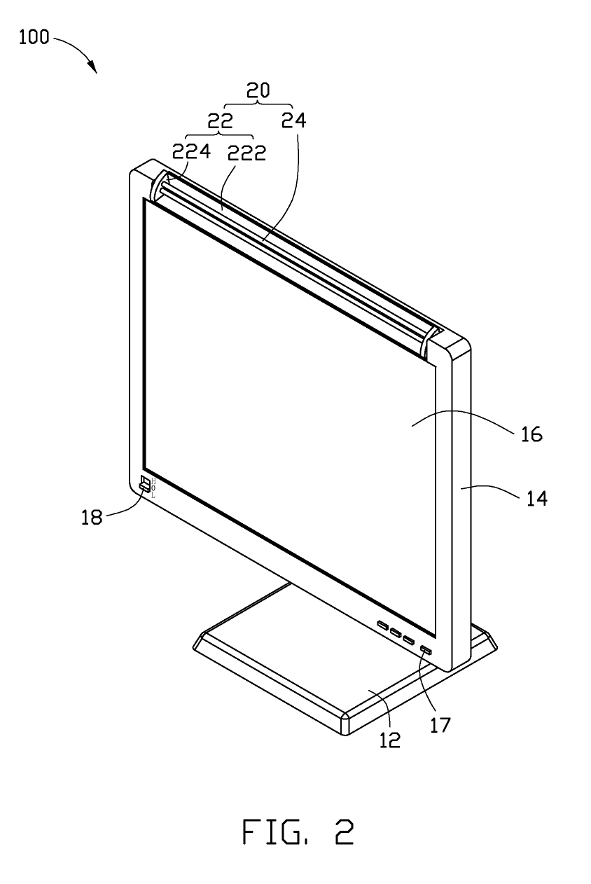

Referring to FIGS. 1-2, a display device 100 according to an exemplary embodiment includes a monitor 10 and an illumination device 20 mounted to the monitor 10. The monitor 10 includes a supporting seat 12, a casing 14 mounted on the supporting seat 12, and a screen 16 mounted in the casing 14. The casing 14 includes a front cover 141 and a back cover 142. A periphery of the screen 16 is attached to the front cover 141. The back cover 142 is fixed to the front cover 141 and covers the back of the screen 16.

The casing 14 defines an elongated slot 140 on the top thereof. The slot 140 is located above a top edge of the screen 16. The slot 140 is concave towards the casing 14 from a top surface 143 and a front surface 144 of the casing 14. A mounting portion 145 is formed on the casing 14 at each end of the slot 140. A mounting hole 146 is defined in a center of each mounting portion 145. At a bottom of the casing 14, a set of regular buttons 17 regulate display parameters of the screen 16 while a control on/off button 18 regulates on/off and brightness of the illumination device 20.

The illumination device 20 includes a lamp holder 22 and a lamp tube 24 mounted in the lamp holder 22. The lamp holder 22 includes a lampshade 222 and two mounting plates 224 disposed at two opposite ends of the lampshade 222. The lamp tube 24 and the lampshade 222 each are elongated. The lampshade 222 has a substantially L-shaped cross-section that includes two connecting plates 222a, 222b connected perpendicularly to each other. The lamp tube 24 is received in a space defined in the lampshade 222, with two ends of the lamp tube 24 being respectively mounted to the mounting plates 224 of the lamp holder 22. A mounting pole 225 extends outwardly from each of the mounting plates 224. The mounting pole 225 has a diameter substantially identical to the mounting hole 146 of the casing 14.

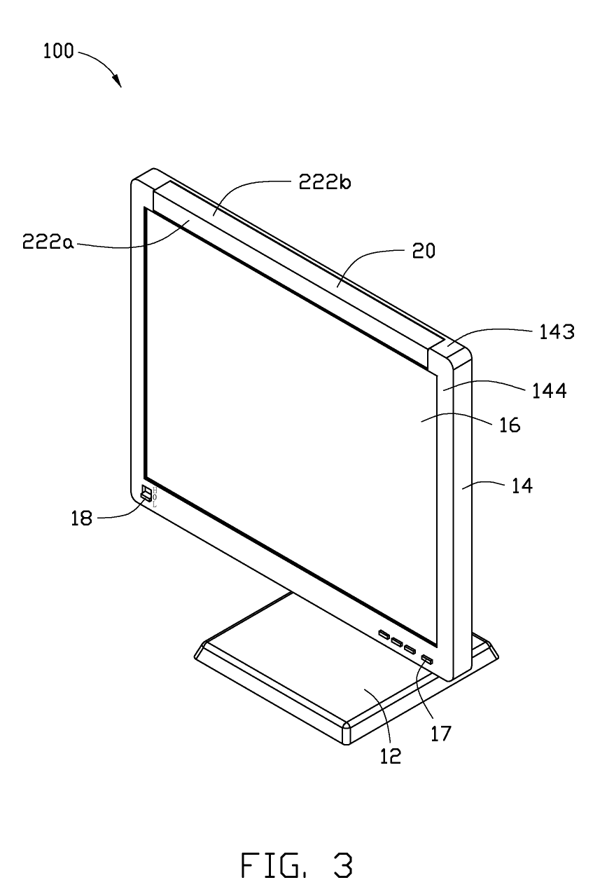

Each mounting pole 225 of the illumination device 20 is mounted in one of the mounting holes 146 of the casing 14, such that the illumination device 20 is mounted in the slot 140 of the casing 14. The illumination device 20 can rotate in the slot 140 around the mounting poles 225. Thus, the illumination device 20 can be rotated to a particular angle according to need of a user, to thereby obtaining a desired illumination angle of the illumination device 20. For example, as shown in FIG. 3, the illumination device 20 is rotated around the mounting poles 225 such that the connecting plates 222a and 222b are coplanar respectively with the front surface 144 and the top surface 143 of the casing 14, thereby increasing the visual effect of the display device 100 when the illumination device 20 is not required.

In the present display device 100, the illumination device 20 is embedded in the casing 14 of the display device 100. Thus, a separate reading lamp is no longer required. When the display device 100 is used in a dim environment, the user can activate the illumination device 20 by depressing control button 18.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A display device, comprising:
a casing;
a screen mounted in the casing, a slot being defined in the casing; and
an illumination device received and mounted in the slot.

2. The display device of claim 1, wherein the slot is elongated and defined in a top of the casing.

3. The display device of claim 2, wherein the slot is concaved inwardly towards the casing from a top surface and a front surface of the casing.

4. The display device of claim 3, wherein the slot is located above a top edge of the screen.

5. The display device of claim 3, wherein a mounting portion is formed on the casing at each end of the slot, and a mounting hole is defined in the mounting portion.

6. The display device of claim 5, wherein the illumination device includes a lamp holder and a lamp tube mounted in the lamp holder, and the lamp holder includes a lampshade and two mounting plates disposed at two opposite ends of the lampshade.

7. The display device of claim 6, wherein a mounting pole extends outwardly from each of the mounting plates, the mounting pole has a diameter substantially the same as that of the mounting holes of the casing, each mounting pole of the illumination device is mounted in one of the mounting holes of the casing.

8. The display device of claim 7, wherein the illumination device is rotatable in the slot around the mounting poles.

9. The display device of claim 8, wherein the lampshade has a substantially L-shaped cross section and includes two connecting plates connected perpendicularly to each other, the lamp tube is received in the lampshade, two ends of the lamp tube being respectively mounted to the mounting plates of the lamp holder.

10. The display device of claim 9, wherein the illumination device is rotated around the mounting poles such that the connecting plates of the illumination device are coplanar respectively with the front surface and the top surface of the casing when the illumination device is not in use.

11. The display device of claim 1, wherein the casing includes a front cover and a back cover, a periphery of the screen is attached to the front cover, and the back cover is fixed to the front cover and covers a back of the screen.

12. The display device of claim 1, wherein a control button is provided on the casing to control on/off and a brightness of the illumination device.
